(19) United States
(12) Patent Application Publication
(10) Pub. No.: US 2016/0178203 A1
(43) Pub. Date: Jun. 23, 2016

(54) APPARATUS AND METHOD FOR PURGING A GAS TURBOMACHINE NOZZLE

(71) Applicant: General Electric Company, Schenectady, NY (US)

(72) Inventors: Pierre Olivier Montagne, Belfort (FR); William James Lawson, Niskayuna, NY (US); John Joseph Lipinski, Simpsonville, SC (US); Rajarshi Saha, Bangalore (IN); Sudhakar Todeti, Bangalore (IN)

(21) Appl. No.: 14/573,696

(22) Filed: Dec. 17, 2014

(51) Int. Cl. F23R 3/28; F02C 3/30; F02C 7/04; F02C 3/04; F02C 7/22

(52) U.S. Cl. CPC F23R 3/28; F02C 3/04; F02C 7/222; F02C 7/04; F02C 3/30; F05D 2220/32; F05D 2240/35

(57) ABSTRACT

A gas turbomachine includes a compressor portion, a turbine portion operatively connected to the compressor portion, and a combustor assembly fluidically connected to the turbine portion. The combustor assembly includes at least one nozzle including at least one fuel gas injector portion and at least one water injector portion. A fuel system is fluidically connected to the at least one nozzle. The fuel system includes at least one fuel gas manifold, a water injector purge manifold and a water injector manifold. The at least one fuel gas manifold is selectively fluidically connectable to the water injector portion of the nozzle through the water injector purge manifold.

### BACKGROUND OF THE INVENTION

The subject matter disclosed herein relates to the art of gas turbomachines and, more particularly, to an apparatus and method for purging a gas turbomachine nozzle.

Turbomachines typically include a compressor portion and a turbine portion. The compressor portion forms a compressed air stream that is introduced into the turbine portion. In a gas turbomachine, a portion of the compressed airstream mixes with products of combustion forming a hot gas stream that is introduced into the turbine portion through a transition piece. In some cases, the products of combustion include un-combusted constituents that contribute to undesirable emissions.

The hot gas stream impacts turbomachine airfoils arranged in sequential stages along the hot gas path. The airfoils are generally connected to a wheel which, in turn, may be connected to a rotor. Typically, the rotor is operatively connected to a load. The hot gas stream imparts a force to the airfoils causing rotation. The rotation is transferred to the rotor. Thus, the turbine portion converts thermal energy from the hot gas stream into mechanical/rotational energy that is used to drive the load. The load may take on a variety of forms including a generator, a pump, an aircraft, a locomotive, or the like.

In some cases, a gas turbomachine may include a water injection nozzle. The water injection nozzle may inject water, along with fuel, into a combustor during gas fuel operation. Water injection contributes to reductions in undesirable emissions that may pass from the turbomachine. When not in use, the water injection nozzle is typically purged with an airflow from the compressor portion. Purging the water injection nozzle reduces localized temperatures and prevents a back flow of combustion products.

### BRIEF DESCRIPTION OF THE INVENTION

According to one aspect of an exemplary embodiment, a gas turbomachine includes a compressor portion, a turbine portion operatively connected to the compressor portion, and a combustor assembly fluidically connected to the turbine portion. The combustor assembly includes at least one nozzle including at least one fuel gas injector portion and at least one water injector portion. A fuel system is fluidically connected to the at least one nozzle. The fuel system includes at least one fuel gas manifold, a water injector purge manifold, and a water injector manifold. The at least one fuel gas manifold is selectively fluidically connectable to the water injector portion of the nozzle through the water injector purge manifold.

According to another aspect of an exemplary embodiment, a gas turbomachine system includes a compressor portion, an air intake system fluidically connected to the compressor portion, a turbine portion operatively connected to the compressor portion, a load operatively connected to one of the compressor portion and the turbine portion, and a combustor assembly fluidically connected to the turbine portion. The combustor assembly includes at least one nozzle including at least one fuel gas injector portion and at least one water injector portion. A fuel system is fluidically connected to the at least one nozzle. The fuel system includes at least one fuel gas manifold, a water injector purge manifold, and a water injector manifold. The at least one fuel gas manifold is selectively fluidically connectable to the water injector portion of the nozzle through the water injector purge manifold.

According to yet another aspect of an exemplary embodiment, a method of operating a gas turbomachine includes introducing a fuel gas into a combustion chamber through a fuel gas injector portion of a nozzle, combusting the first fuel gas, injecting water into the combustion chamber through a water injector portion of the nozzle during a first combustion operation, and purging the water injector portion of the nozzle with fuel gas during a second combustion operation.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a gas turbomachine system including a fuel system, in accordance with an exemplary embodiment;

FIG. 2 is a schematic view of a portion of the fuel system in a first operating condition; and

FIG. 3 is a schematic view of the fuel system in a second operating condition.

The detailed description explains embodiments of the invention, together with advantages and features, by way of example with reference to the drawings.

### DETAILED DESCRIPTION OF THE INVENTION

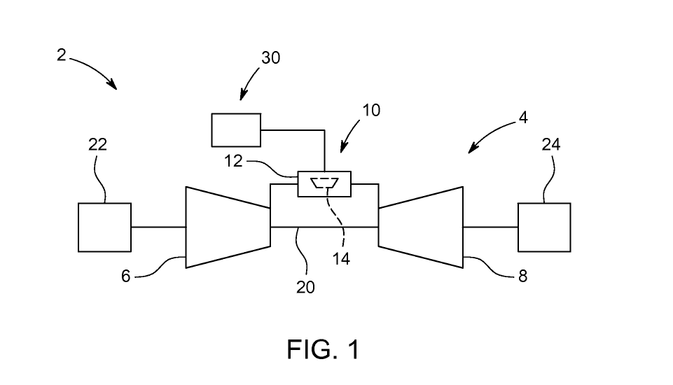

A gas turbomachine system, in accordance with an exemplary embodiment, is indicated generally at 2, in FIG. 1. Gas turbomachine system 2 includes a gas turbomachine 4 having a compressor portion 6 operatively connected to a turbine portion 8. A combustor assembly 10, including at least one combustor 12, is fluidically connected between compressor portion 6 and turbine portion 8. Combustor 12 includes at least one nozzle 14. Compressor portion 6 may be linked to turbine portion 8 through a common compressor/turbine shaft 20. An air intake system 22 may be fluidically connected to an inlet (not separately labeled) of compressor portion 6. Air intake system 22 may condition an airflow passing into compressor portion 6. A load 24 is operatively connected to one of turbine portion 8 and compressor portion 6. Load 24 may be driven by energy produced by gas turbomachine 4 and may take on a variety of forms.

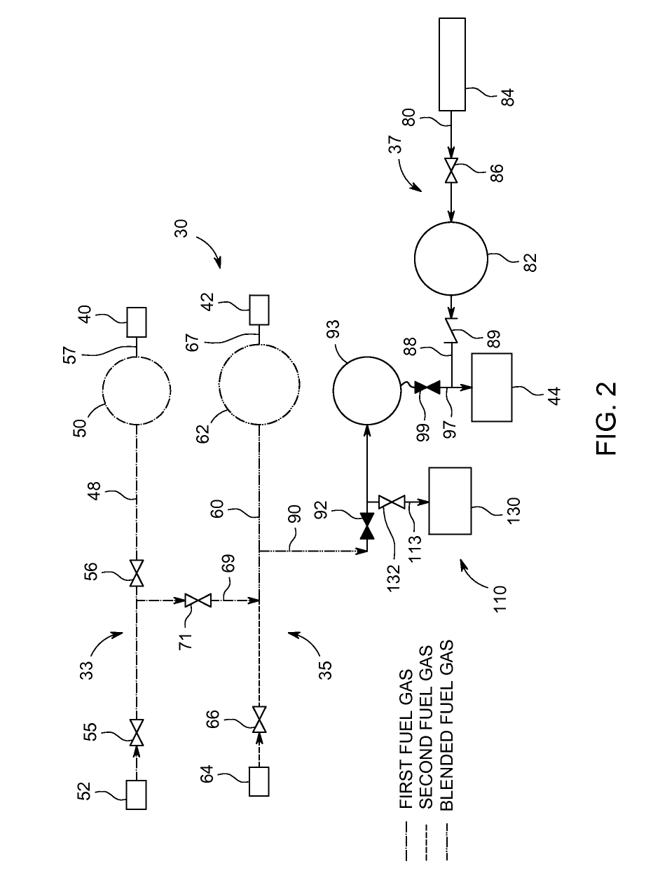

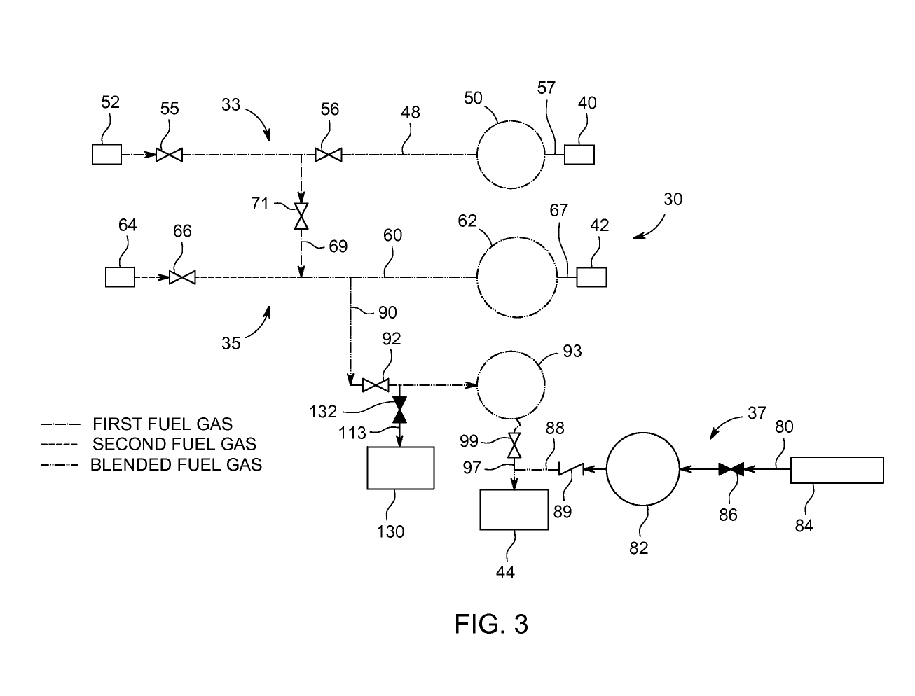

Referring to FIGS. 2 and 3, in accordance with an exemplary embodiment, gas turbomachine system 2 includes a fuel system 30. The fuel system 30 may include a first fuel gas system 33, a second fuel gas system 35, and a water injection system 37. First fuel gas system 33 delivers a first fuel gas, such as syngas, into a first fuel gas injector portion 40 of nozzle 14. Second fuel gas system 35 delivers a second fuel gas, such as natural gas, into a second fuel gas injector portion 42 of nozzle 14. Water injection system 37 delivers water into a water injector portion 44 of nozzle 14 during select operating periods. In the exemplary aspect shown, first fuel gas injector portion 40 is positioned radially outwardly of second fuel gas injector portion 42. First and second fuel gas injector portions 40 and 42 are positioned radially outwardly of water injector portion 44. Thus, in the exemplary aspect shown, water injection occurs centrally through nozzle 14. The introduction of water into a combustion chamber portion (not separately labeled) during various operating periods may reduce undesirable exhaust constituents such as NOx.

First fuel gas system 33 includes a first conduit 48 that fluidically links a first fuel gas manifold 50 with a source 52 of the first fuel gas through a first valve 55 and a second valve 56. First fuel gas manifold 50 is fluidically connected to first fuel gas injector portion 40 through a conduit 57. Second fuel gas system 35 includes a second conduit 60 that fluidically links a second fuel gas manifold 62 with a source 64 of the second fuel gas through a third valve 66. Second fuel gas manifold 62 is fluidically connected to second fuel gas injector portion 42 through a conduit 67. A first bypass conduit 69 fluidically connects first conduit 48, between first and second valves 55 and 56, with second conduit 60 downstream of third valve 66. First bypass conduit 69 includes a first bypass valve 71 that may be configured for a unidirectional flow. First bypass conduit 69 provides a fluidic connection between the source of first fuel gas 52 and second fuel gas injector portion 42. In this manner, the first fuel gas, e.g., syngas may pass through first fuel gas injector portion 40 and through second fuel gas injector portion 42 via bypass conduit 69. Second fuel gas, e.g., natural gas, may flow to second fuel gas injector portion 42. The second fuel gas is restricted from flowing through first fuel gas injector portion 40.

Fuel system 30 further includes a third conduit 80 fluidically connecting a water injector manifold 82 with a source of water 84 through a fourth valve 86. Water injector manifold 82 is fluidically connected to water injector portion 44 through a conduit 88. A unidirectional valve 89 is arranged along conduit 88 between water injector manifold 82 and the water injector portion 44. Fuel system 30 also includes a second bypass conduit 90 fluidically connected to second conduit 60 downstream of third valve 66 and first bypass valve 71 and upstream of second fuel gas manifold 62. A second bypass valve 92 provides passage of the first fuel gas, the second fuel gas or combinations thereof, through second bypass conduit 90 to a water injector purge manifold 93. A conduit 97 is fluidly connected between the water injector purge manifold 93 and the water injector portion 44.

During operation of the water injection system 37, the second bypass valve 92 is closed, thereby not allowing flow of the first fuel gas 52 and/or the second fuel gas 64 into the water injector purge manifold 93 or to locations downstream of the water injector purge manifold 93. Such an operating condition is illustrated in FIG. 2.

As shown in FIG. 3, during a non-operational condition of the water injection system 37, the water injector purge manifold 93 allows water to be selectively purged from conduit 88. This is facilitated by opening of the second bypass valve 92 and an isolation valve 99 arranged along conduit 97 to allow the first fuel gas 52 and/or the second fuel gas 64 to flow into the water injection purge manifold 93 and into the water injector portion 44 of the fuel nozzle 14. In this manner, the first and/or second fuel gas 52 and/or 64 provides a purge flow through water injector portion 44. While shown as being fluidically connected to nozzle 14 of combustor 12, it should be understood that fuel system 30 may also be connected to other nozzles 14 and/or combustors (not shown) of combustor assembly 10.

In accordance with an exemplary embodiment, combustor may be operated in a variety of combustion configurations. For example, during a first operational mode, first and second fuel gas may be combusted. The first operational mode may include water injection. The injection of water reduces undesirable exhaust constituents such as NOx. In other operational modes, there may be little to no need for water injection. During such operational modes, a purge gas is passed through water injector portion. The purge gas prevents backflow into water injector manifold. The purge gas also reduces localized temperatures at water injector portion. In accordance with exemplary embodiments, the purge gas takes the form of the first and/or second fuel gas. The use of fuel gas for purging water injector portion reduces nozzle damage by providing a flow of cooling gas at a tip portion of nozzle and also alleviates the need for a booster compressor and cooler if using air as a purge gas.

Fuel system 30 further includes a drain system 110 having a drain conduit 113. More specifically, after a purge with the first fuel gas 52, water injector purge manifold 93 may be fluidically connected to a storage portion 130 through a drain valve 132. Similarly, after a purge with the second fuel gas 64, water injector purge manifold 93 may be fluidically connected to storage portion 130 through a drain valve 132. Further, after water injection and prior to purging, water injector purge manifold 93 may be fluidically connected to storage portion 130 through drain valve 132. Storage portion 130 may be connected to a separator (not shown) that removes water from the first and/or second fuel gases 52, 64. Alternatively, as one can appreciate, the first and/or fuel gas 52, 64 may be removed from the water.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A gas turbomachine comprising:
a compressor portion;
a turbine portion operatively connected to the compressor portion;
a combustor assembly fluidically connected to the turbine portion, the combustor assembly including at least one nozzle including at least one fuel gas injector portion and at least one water injector portion; and
a fuel system fluidically connected to the at least one nozzle, the fuel system including at least one fuel gas manifold, a water injector purge manifold, and a water injector manifold, the at least one fuel gas manifold being selectively fluidically connectable to the at least one water injector portion of the nozzle through the water injector purge manifold.

2. The gas turbomachine according to claim 1, wherein the fuel system includes a first fuel gas manifold and a second fuel gas manifold, wherein at least one of the first and second fuel gas manifolds is selectively connectable to the at least one water injector portion of the nozzle.

3. The gas turbomachine according to claim 2, wherein each of the first and second fuel gas manifolds is selectively connectable to the at least one water injector portion of the nozzle.

4. The gas turbomachine according to claim 1, further comprising a drain conduit fluidically connected to the at least one water injector portion of the nozzle.

5. The gas turbomachine according to claim 4, wherein the drain conduit is selectively connectable to a storage portion.

6. A gas turbomachine system comprising:
a compressor portion;
an air intake system fluidically connected to the compressor portion;
a turbine portion operatively connected to the compressor portion;
a load operatively connected to one of the compressor portion and the turbine portion;
a combustor assembly fluidically connected to the turbine portion, the combustor assembly including at least one nozzle including at least one fuel gas injector portion and at least one water injector portion; and
a fuel system fluidically connected to the at least one nozzle, the fuel system including at least one fuel gas manifold, a water injector purge manifold, and a water injector manifold, the at least one fuel gas manifold being selectively fluidically connectable to the at least one water injector portion of the nozzle through the water injector purge manifold.

7. The gas turbomachine system according to claim 6, wherein the fuel system includes a first fuel gas manifold and a second fuel gas manifold, wherein at least one of the first and second fuel gas manifolds is selectively connectable to the at least one water injector portion of the nozzle.

8. The gas turbomachine system according to claim 7, wherein each of the first and second fuel gas manifolds is selectively connectable to the at least one water injector portion of the nozzle.

9. The gas turbomachine system according to claim 6, further comprising a drain conduit fluidically connected to the at least one water injector portion of the nozzle.

10. The gas turbomachine system according to claim 9, wherein the drain conduit is selectively connectable to a storage portion configured to store water, the first fuel gas and the second fuel gas.

11. The gas turbomachine system according to claim 10, further comprising a separator operatively connected to the storage portion to remove at least one of water, the first fuel gas and the second fuel gas.

12. The gas turbomachine system according to claim 6, wherein the water injector manifold is arranged between a water supply and the water injector portion, the system further comprising a unidirectional valve disposed between the water injector manifold and the water injector portion.

13. The gas turbomachine system according to claim 6, further comprising an isolation valve disposed between the water injector purge manifold and the water injector portion.

14. A method of operating a gas turbomachine comprising:
introducing a fuel gas into a combustion chamber through a fuel gas injector portion of a nozzle;
combusting the fuel gas;
injecting water into the combustion chamber through a water injector portion of the nozzle during a first combustion operation; and
purging the water injector portion of the nozzle with fuel gas during a second combustion operation.

15. The method of claim 14, wherein introducing the fuel gas includes injecting at least one of natural gas (NG) and syngas into the combustion chamber.

16. The method of claim 14, wherein purging the water injector portion includes passing at least one of natural gas (NG) and syngas into the combustion chamber through the water injector portion.

17. The method of claim 14, wherein purging the water injector portion includes passing natural gas (NG) and syngas into the combustion chamber through the water injector portion.

18. The method of claim 14, further comprising: selectively connecting the water injector portion to a drain conduit.

19. The method of claim 18, wherein selectively connecting the water injector portion to the drain conduit includes selectively connecting the water injector portion to a storage portion configured to store water, the first fuel gas and the second fuel gas.

20. The method of claim 19, further comprising removing at least one of water, the first fuel gas and the second fuel gas from the storage portion with a separator operatively connected to the storage portion.
